(19) United States
(12) Patent Application Publication
(10) Pub. No.: US 2022/0093994 A1
(43) Pub. Date: Mar. 24, 2022

(54) ELECTRIC BATTERY MODULE AND BATTERY COMPRISING AT LEAST ONE SUCH MODULE

(71) Applicant: SOGEFI AIR & COOLING, GUYANCOURT (FR)

(72) Inventors: Nicolas BECKER, PORTE DU RIED (FR); Boris COLIN, ORBEY (FR)

(21) Appl. No.: 17/418,675

(22) PCT Filed: Dec. 23, 2019
(86) PCT No.: PCT/EP2019/086906

§ 371 Date: Jun. 25, 2021

(30) Foreign Application Priority Data
Dec. 28, 2018 (FR) 1874281

(51) Int. Cl. H01M 10/6568; H01M 10/653; H01M 10/6555; H01M 50/213; H01M 10/0525

(52) U.S. Cl. CPC H01M 10/6568; H01M 10/653; H01M 2220/20; H01M 50/213; H01M 10/0525; H01M 10/6555

(57) ABSTRACT

The invention relates to an electric battery module (1) comprising a plurality of individual accumulators (2) in the form of cylindrical elements mounted in a container (3).

Said battery module (1) is characterized in that said container (3) comprises:
at least one support body (4) which defines a plurality of elongate housings that each receive a row (Ri) of battery elements (2),
first wedging elements (6) in the form of ladder- or frame-like perforated components which comprise side members and crossmembers, arranged such that each battery element (2) is fixed in position at least in the longitudinal direction (DL) of its elongate housing with respect to said first wedging elements (6),
at least one second wedging element (7) which is mounted above the elongate housings and arranged so as to urge the first wedging elements (6) toward the bottoms of said elongate housings and against the battery elements (2) that they frame in pairs.

The present invention relates to the field of the storage of electrical energy, more particularly that of electric batteries comprising a plurality of individual accumulators, in particular batteries for motor vehicles, and the subjects thereof are a battery module and a battery comprising at least one such module.

Many batteries, in particular with great autonomy and high power, in particular batteries on board combustion engine vehicles, hybrid vehicles and electric vehicles, are currently made up of a large number of individual battery elements (elementary accumulators), in particular of the Li-ion or Li-polymer type.

Each of these elements is, as standard, in the form of a sealed and electrically insulated cylinder provided with connection terminals at its opposite ends or at one end. In order to be kept fixed in the assembled state, they are connected together, generally by adhesive bonding or resin bonding, in blocks or packs, on one or more stage(s).

However, such an assembly held together with a binder material exhibits drawbacks.

Thus, when the number thereof is high, overheating (on account of a short-circuit or a malfunction) of an element may damage the entire battery by contamination and amplification caused by the confinement. Moreover, temperature control of the internal elements of such a pack by natural ventilation is problematic, if not impossible. Moreover, in the event of one element of a pack failing, the entire pack has to be changed. Lastly, the integrity over time of the material assembly under demanding climatic conditions and/or in a harsh vibratory environment is questionable and the quality of production of the assembly may be dubious and variable.

In order to try to overcome these drawbacks, means for mechanically joining the elements together, in a protective casing, have been proposed.

However, generally, these known solutions employ a large number of separate holding parts, requiring an outer shell that is strong and able to take up the internal stresses, involving tedious assembly operations, and/or are not designed for the purpose of effective thermal control of all of the elements, or for protecting the majority of the elements if just one of them fails.

Therefore, the problem addressed by the invention consists, first, in providing a simple battery embodiment in which the elements are held, individually, securely in place without a material connection or bonding between one another, and are advantageously protected if one of them fails, specifically with the aid of only mechanical means.

Moreover, the proposed embodiment should provide improved thermal control compared with the known solutions, without the design being more complex and without the need for forced ventilation.

Lastly, the proposed embodiment should be able to be easily adaptable to battery formats of variable size and power, and easy to manufacture, with identical base components and a similar assembly process, preferably in two successive aggregation phases, regardless of the final battery format.

At least the main problem above is solved by the invention by virtue of an electric battery module, in particular a motor vehicle battery module, comprising a plurality of individual accumulators in the form of battery elements or cells, of elongate, advantageously cylindrical, shape, preferably with a circular section, these battery elements being connected electrically together and to the connection terminals of the module and mounted in a container forming part of said module,

said battery module being characterized in that said container comprises:
at least one support body which defines a plurality of mutually parallel elongate housings that are configured in the form of grooves or channels each for receiving a row of battery elements with their longitudinal axes perpendicular to the bottom of the housing in question,
first wedging elements in the form of ladder- or frame-like perforated components which comprise side members and crossmembers, disposed against and between the battery elements of a row and each of the two lateral walls of the elongate housing receiving them, wherein each crossmember is situated between two adjacent battery elements with which it is in contact, such that each battery element is fixed in position at least in the longitudinal direction of its elongate housing with respect to said first wedging elements,
at least one second wedging element which is mounted above the elongate housings and has projections that engage under pressure with the first wedging elements so as to urge the latter toward the bottoms of said elongate housings and against the battery elements that they frame in pairs.

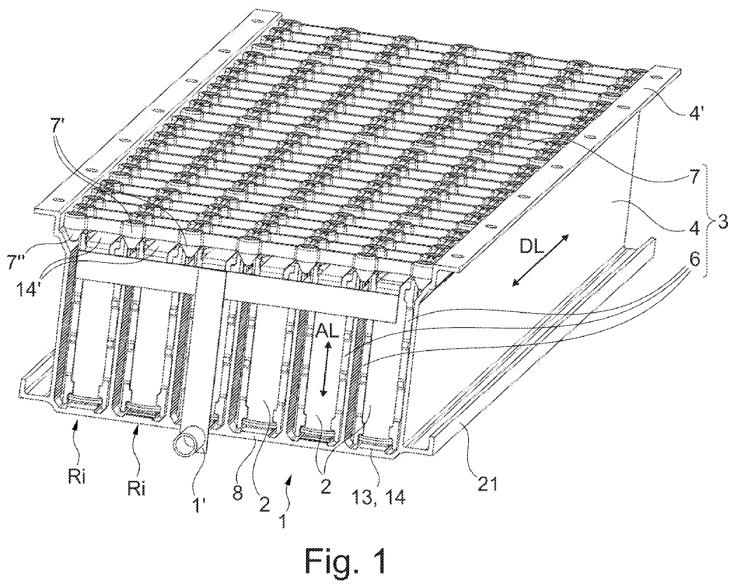

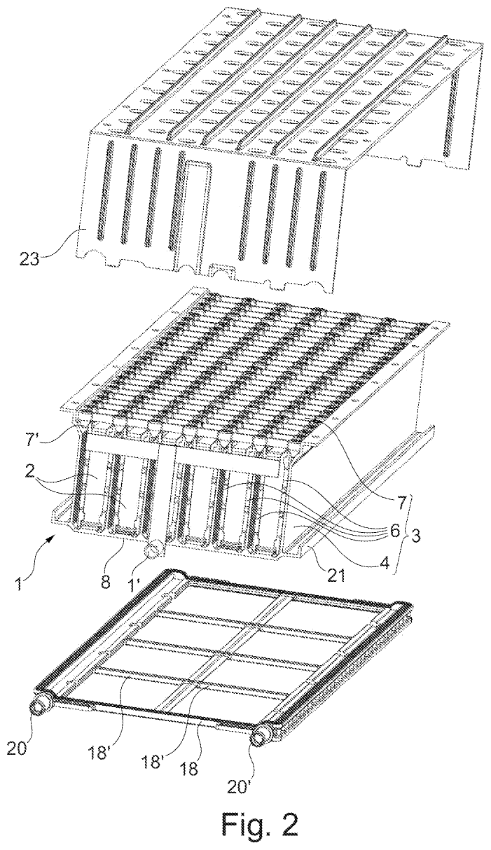

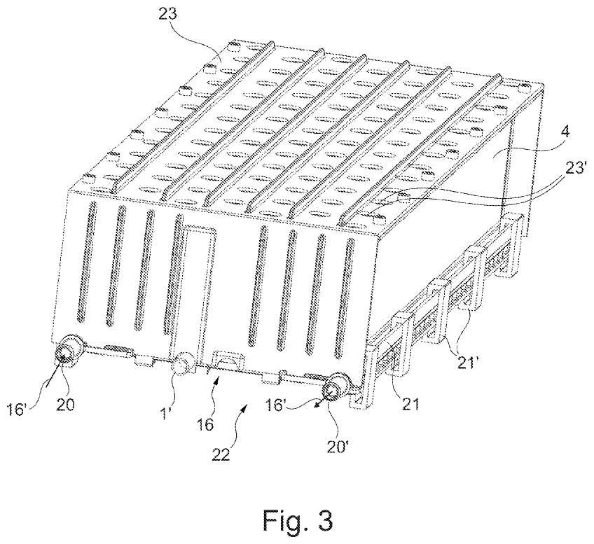

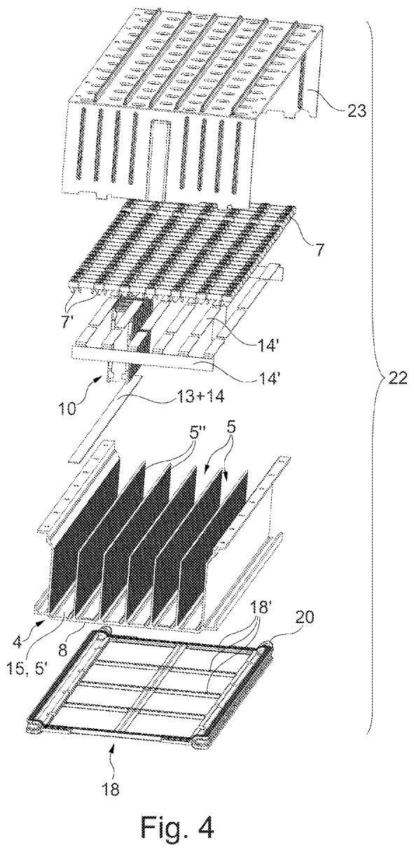

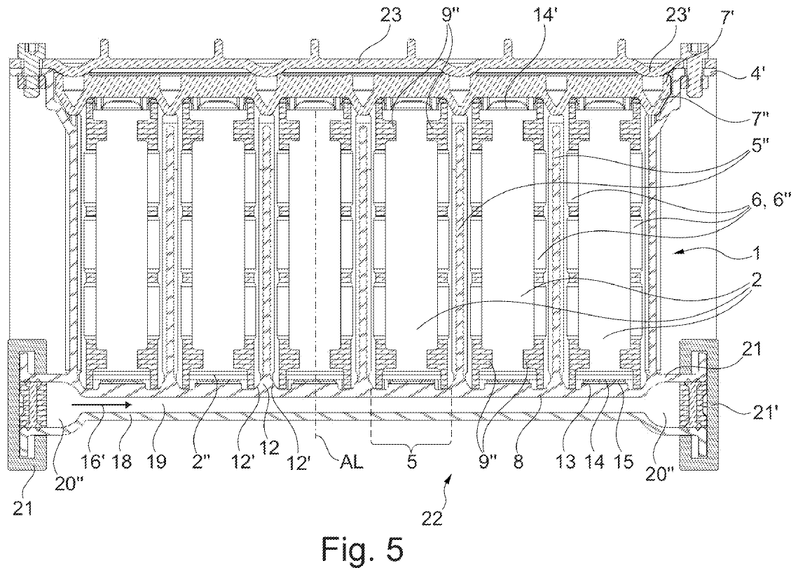

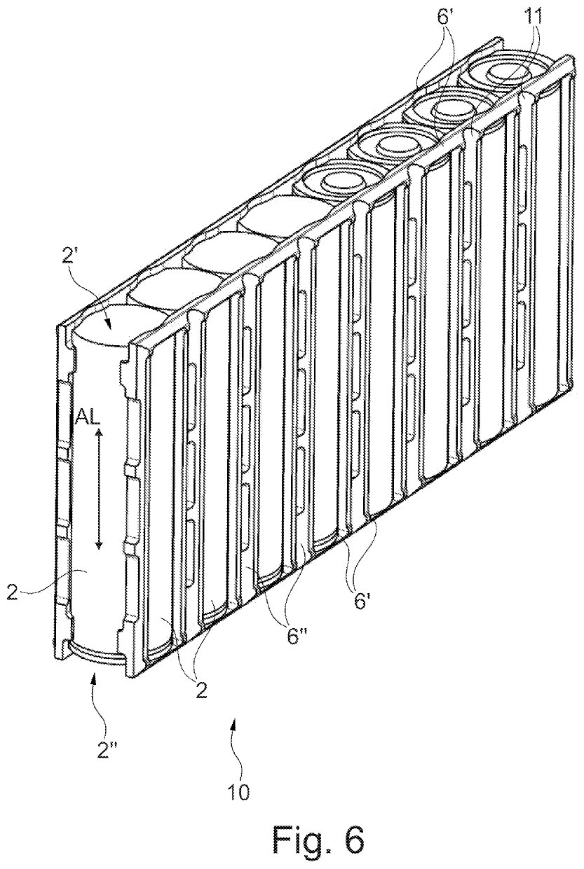

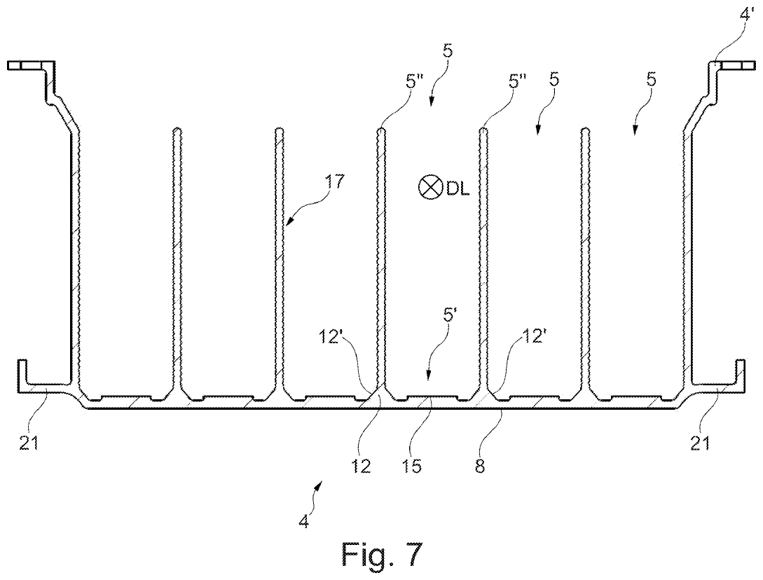

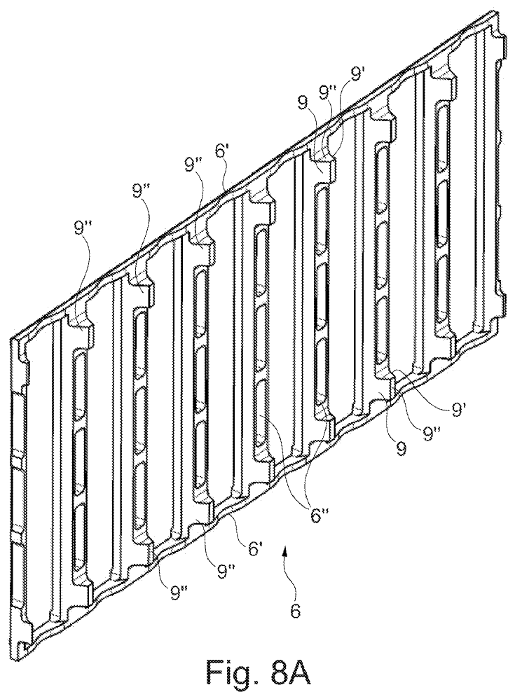

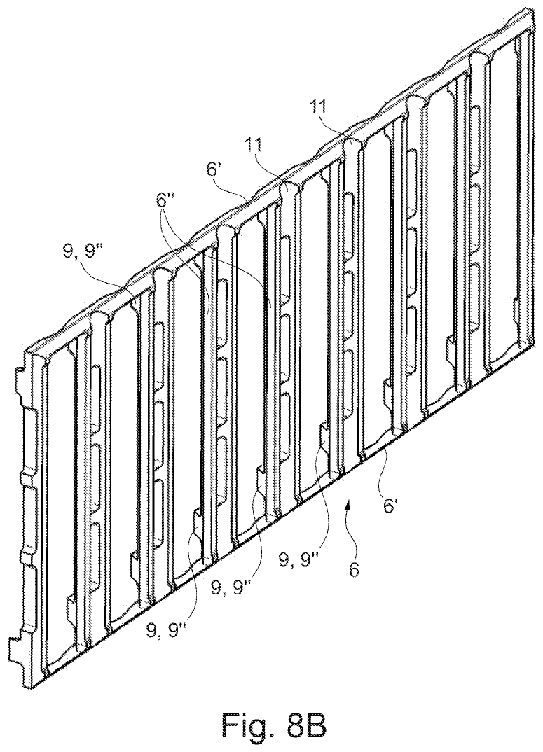

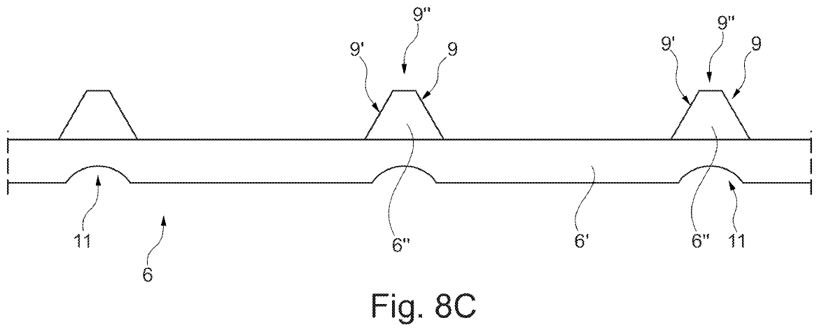

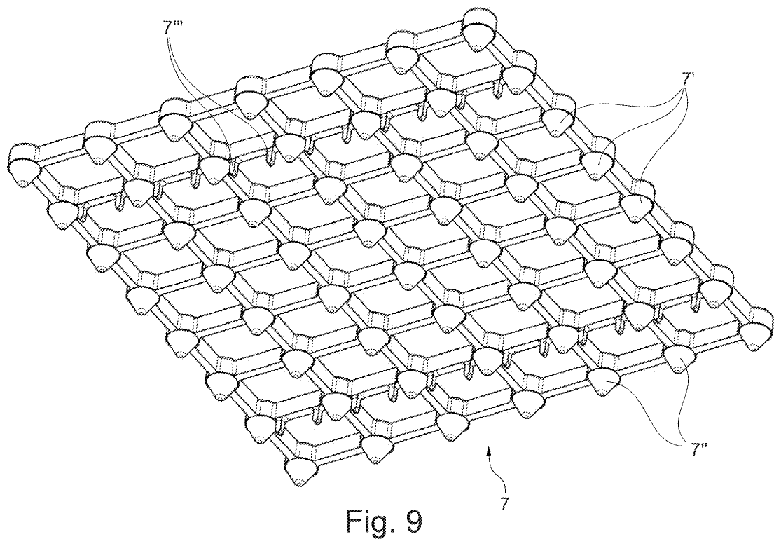

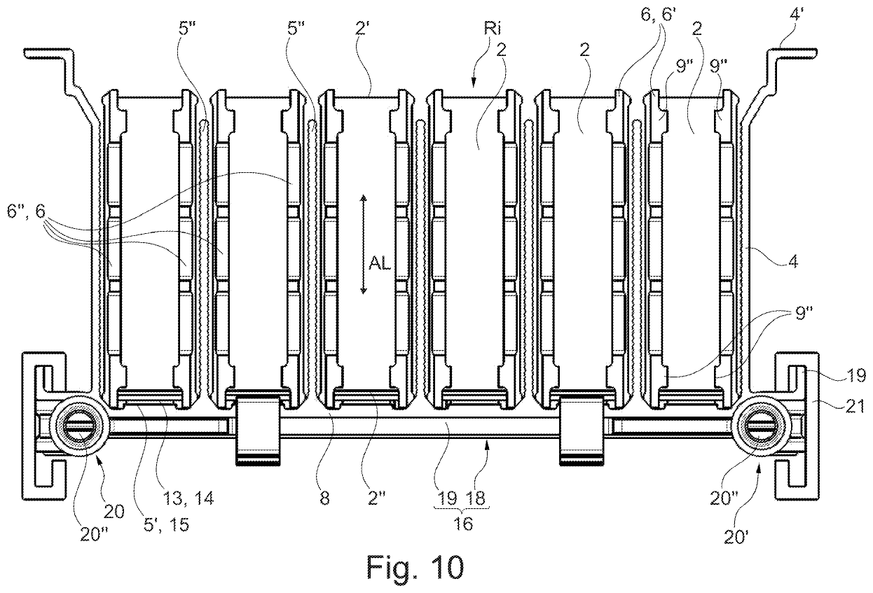

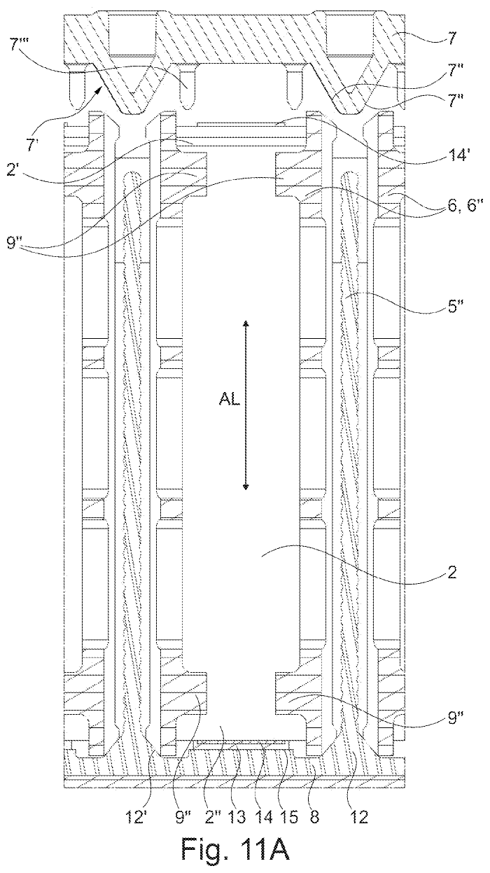

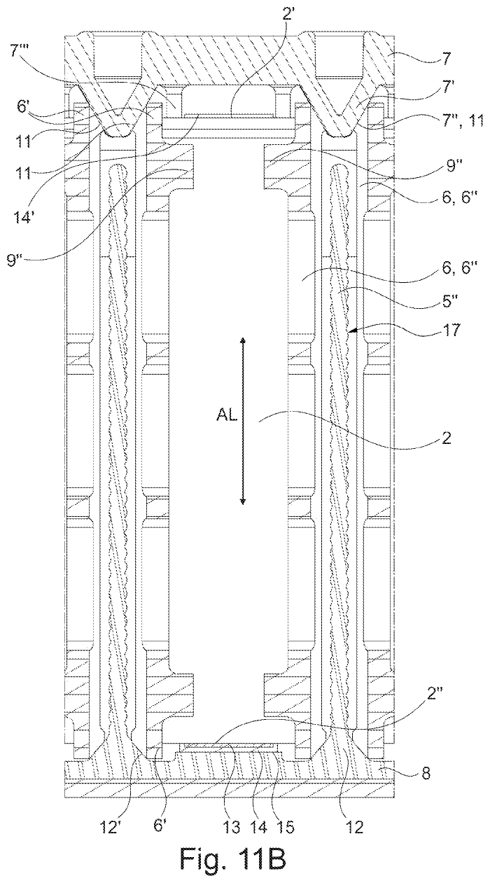

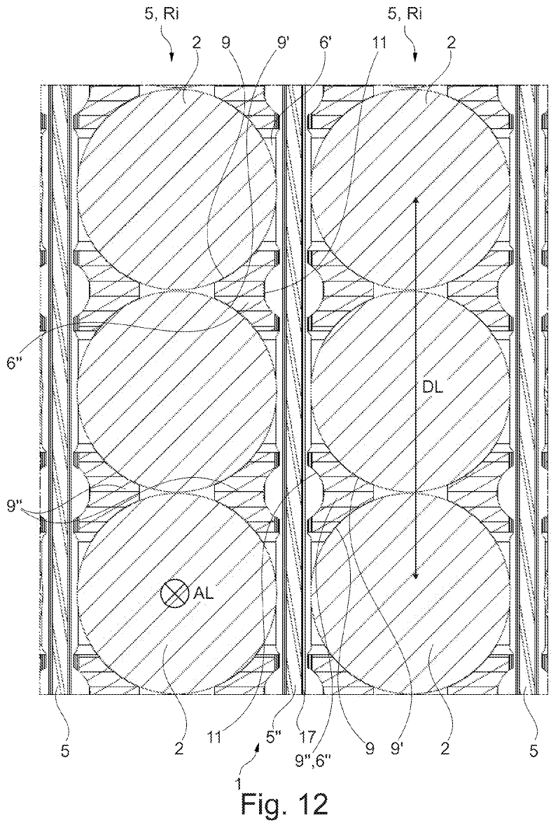

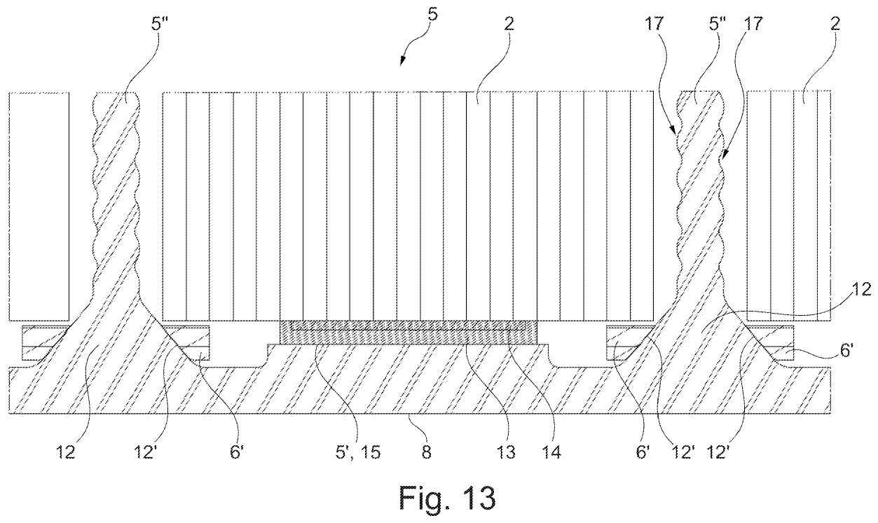

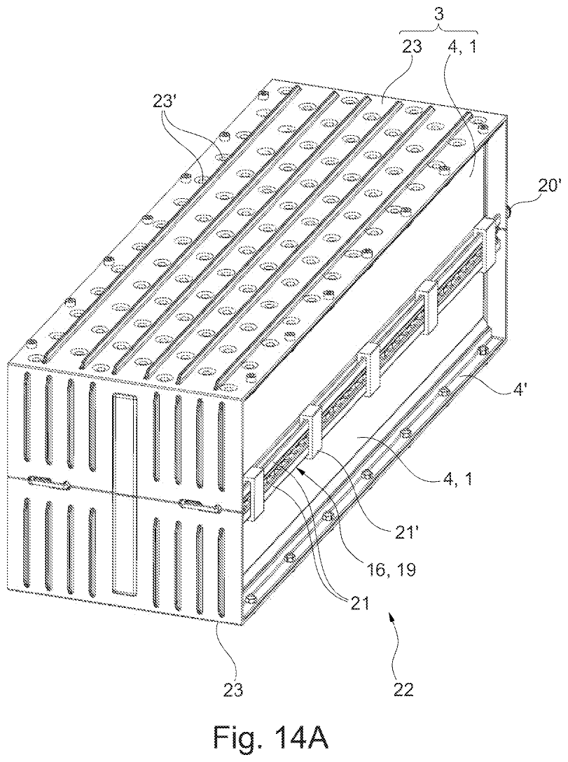

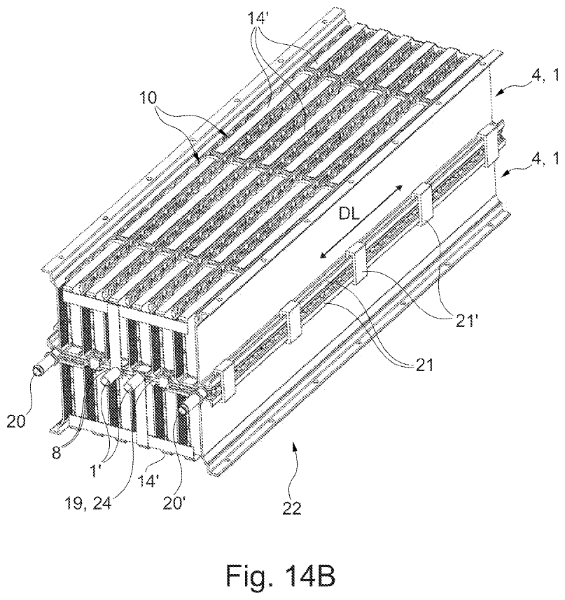

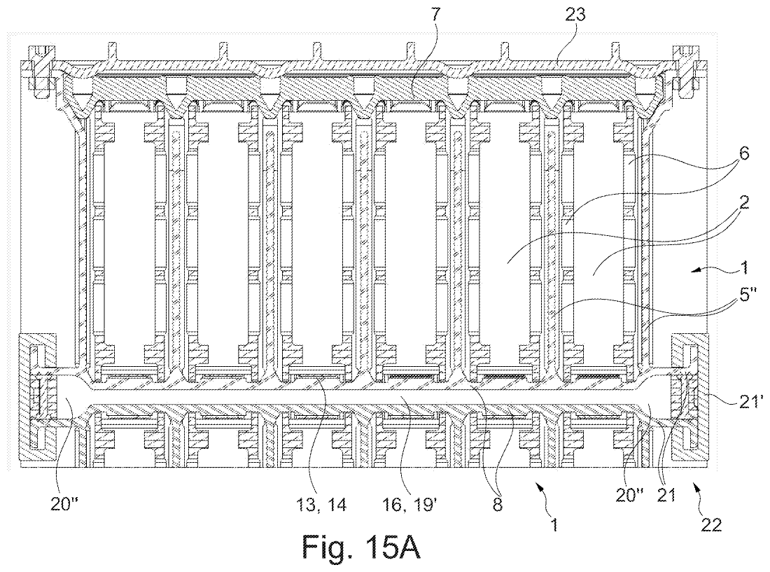

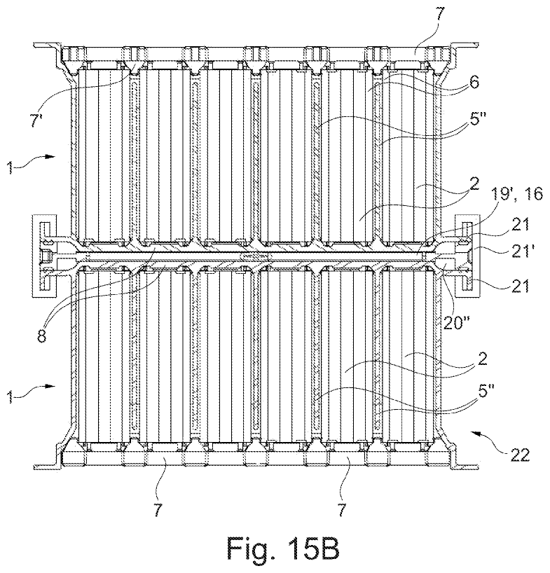

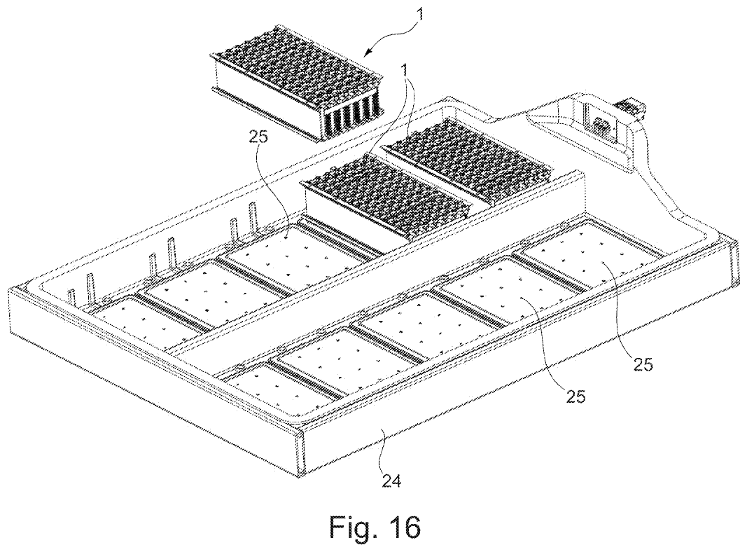

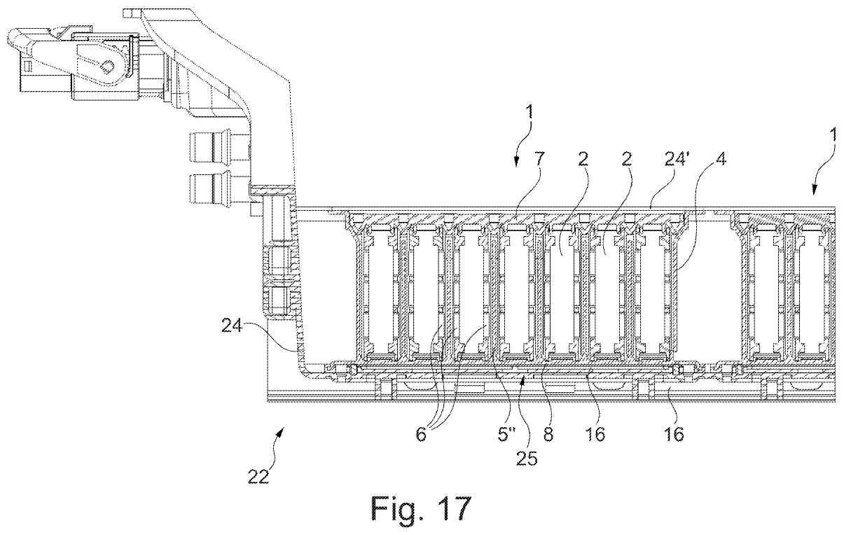

The invention will be understood better by virtue of the following description, which relates to preferred embodiments that are given by way of nonlimiting examples and are explained by reference to the appended schematic drawings, in which:

[FIG. 1] is a perspective view of a battery module according to the invention;

[FIG. 2] is a partially exploded view of a battery according to a first embodiment of the invention, incorporating a single battery module as shown in FIG. 1;

[FIG. 3] is a perspective view of the battery in FIG. 2 in the joined-together state;

[FIG. 4] is an exploded perspective view of the various constituent elements of a battery according to the invention as shown in FIGS. 2 and 3 and in accordance with the first embodiment (for reasons of clarity, only one block of battery elements is shown);

[FIG. 5] is a truncated cross-sectional view, on a plane perpendicular to the longitudinal direction of the receiving housings for the battery elements, of the battery shown in FIG. 3;

[FIG. 6] is a perspective view of a block of battery elements according to the invention, which can also be seen in FIG. 4;

[FIG. 7] is a sectional view of a support body forming part of the container of a battery module according to the invention;

[FIG. 8A] and

[FIG. 8B] are perspective views in two different directions of a first wedging element or means forming part of a module according to the invention;

[FIG. 8C] is a partial top view of a first wedging elements as shown in FIGS. 8A et 8B;

[FIG. 9] is a perspective view of a second wedging element or means forming part of a module according to the invention;

[FIG. 10] is a sectional view similar to the one in FIG. 5 of a module that is only partially assembled, is equipped with a temperature control means but does not have a second wedging element;

[FIG. 11A] is a partial detail view, on a different scale, taken from the sectional view in FIG. 10, during the fitting of a second wedging means or element;

[FIG. 11B] is a view identical to the one in FIG. 11A, after the second wedging element has been fitted;

[FIG. 12] is a partial top view, on a different scale, of the partially assembled battery module in FIG. 10;

[FIG. 13] is a detail view, on a different scale, of the bottom wall and of the lower end of a battery module as shown in FIGS. 11A and 11B;

[FIG. 14A] is a perspective view of a second embodiment of a battery incorporating two battery modules according to the invention, joined together by their respective bottom walls;

[FIG. 14B] is a perspective view of the battery shown in FIG. 14A, seen at a different angle and with the covers having been removed;

[FIG. 15A] is a partial sectional view, on a plane perpendicular to the longitudinal direction of the elongate housings receiving the battery elements, of the battery shown in FIG. 14A;

[FIG. 15B] is a sectional view of the two battery modules of a battery according to FIG. 14A, on a section plane similar to the one in FIG. 15A, according to another embodiment;

[FIG. 16] is a perspective view of a third embodiment of a battery incorporating a plurality of battery modules according to the invention, this battery being in the course of being assembled; and

[FIG. 17] is a partial cross-sectional view of the battery in FIG. 16.

FIGS. 1, 2, 4, 5, 10, 11, 14 to 17 all show, in some cases only in part, an electric battery module 1, in particular a motor vehicle battery module, comprising a plurality of individual accumulators 2 in the form of battery elements or cells, of elongate, advantageously cylindrical, shape, preferably with a circular section, these battery elements 2 being connected electrically together and to the connection terminals 1′ of the module 1 and mounted in a container 3 forming part of said module 1.

In accordance with the invention, said container 3 comprises:
at least one support body 4 which defines a plurality of mutually parallel elongate housings 5 that are configured in the form of grooves or channels each for receiving a row Ri of battery elements 2 with their longitudinal axes AL perpendicular to the bottom 5′ of the housing 5 in question,
first wedging elements 6 in the form of ladder- or frame-like perforated components which comprise side members 6′ and crossmembers 6″, disposed against and between the battery elements 2 of a row Ri and each of the two lateral walls 5″ of the elongate housing 5 receiving them, wherein each crossmember 6″ is situated between two adjacent battery elements 2 with which it is in contact, such that each battery element 2 is fixed in position at least in the longitudinal direction DL of its elongate housing 5 with respect to said first wedging elements 6,
at least one second wedging element 7 which is mounted above the elongate housings 5 and has projections 7′ that engage under pressure with the first wedging elements 6 so as to urge the latter toward the bottoms 5′ of said elongate housings 5 and against the battery elements 2 that they frame in pairs.

Thus, by providing a profiled support body 4 with a comb-shaped section, the plurality of battery elements 2, although remaining grouped together (high power density), is stored in a manner segmented into rows Ri by compartmentalizing walls 5″ of the support body 4, the latter thus allowing them to be kept firmly in place, to be separated physically and electrically (mutual isolation of the rows Ri) and to be thermally controlled effectively (individualized arrangement and holding of the elements 2 with creation of air-circulation gaps).

The precise and individual holding of the battery elements 2 in the grooves 5 of the support body 4 provided by the first wedging means 6 allows the formation and maintenance of air-circulation gaps along the rows Ri, and around and possibly between the elements 2 of each row.

As shown in particular in FIGS. 4, 6, 8 and 12, the battery elements 2 of one and the same row Ri are advantageously confined between at least one pair of ladders 6, each element 2 preferably being wedged between four crossmembers 6″ and four side-member portions 6′, each of which connects together (at the top or bottom) two crossmembers 6″ (of one and the same ladder 6) from the four abovementioned crossmembers 6″.

Thus, each pair of ladders 6 is shown in a profiled housing 5 in a layered manner (that is to say with their side members 6′ parallel to the longitudinal direction DL of the housing 5 in question) and provided with individual perforated recesses for receiving battery elements 2 in a wedged manner. Each ladder 6 may extend along the entire length of a housing 5 or preferably along only a whole fraction thereof.

The second wedging element(s) 7, preferably with surface extension, help to promote the interaction between the perforated components 6 (forming the first wedging elements 6 and framing, in pairs, the battery elements 2 between one another), for the one part, and the elements 2 that they sandwich between one another, for the other part. This/these second wedging element(s) 7 also complete(s) the locking of said elements 2 in position in the space by way of the first wedging element 6 and by acting on the latter.

In addition, this/these second wedging element(s) 7 also help, of course, on account of its/their shape and its/their position, to keep, in the support body 4, the ladders 6 and the battery elements 2, which the latter frame and confine, in the profiled housings 5.

The or each second wedging element 7 may either by fixed directly to the support body 4 or be held on and against the latter under pressure by a cover 23, or both.

In a similar way to the first wedging elements 6, the second wedging element(s) 7 advantageously also has/have a perforated shape allowing a free circulation of the air in the container 3. In addition, by urging the first wedging elements 6 toward the battery elements 2, the second wedging element(s) 7 keep said elements 2 and 6 away from the lateral walls 5″ (at least in the upper part, at the free edges of the walls 5″).

Preferably, the support body 4 consists of a profiled component of comb-shaped cross section, comprising a plurality of parallel compartmentalizing walls 5″ that are regularly spaced apart from one another and form, with a common bottom wall 8, the elongate housings 5 (FIGS. 4, 5 and 7 in particular).

The battery elements 2, which are arranged in simple alignments and each have a cylindrical shape, are consequently exposed over their entire lateral surface to the air flows that circulate and are controlled by the support body 4, in particular when said elements are kept at a small distance from one another by the first wedging elements 6 (for example by providing projections 9″ in the form of wedges with curved contact zones 9, 9′—see FIGS. 8 and 12).

In addition to locking the battery elements 2 in position in multiple directions (two axes and one half-axis), the support body 4 of comb-shaped section also forms, with its two exterior lateral walls and its bottom wall, a protective shell.

According to one feature of the invention, which can be seen in particular in FIGS. 1, 2, 5 and 10 to 12, each battery element 2 is, in a plane perpendicular to its longitudinal axis AL, kept in position between two first wedging elements 6 by at least linear, preferably surface, contact with two pairs of crossmembers 6″, each pair belonging to one of said abovementioned first wedging elements 6, said crossmembers 6″ being advantageously configured and arranged such that each battery element 2 is positioned fixedly at a distance, for the one part, from two opposite lateral walls 5″ of the housing 5 that receives it and, for the other part, from the adjacent battery elements 2, with respective determined spacings.

Advantageously, each crossmember 6″ has, along at least a part of its length, continuously or discontinuously, at least one pair of beveled, flat or curved, contact surfaces 9, 9′ that are intended to come into contact with two adjacent battery elements 2 of a row Ri.

The beveled surfaces 9, 9′ may for example be formed by the inclined surfaces of upper and lower projections 9″, which are in one piece with the crossmembers 6″ and form wedges or stop blocks that are tapered or the like, being positioned between two battery elements 2 in the joined-together state of the module 1.

According to one very favorable feature of the invention, illustrated in particular in FIGS. 5, 6, 10, 11 and 12, those portions of upper and lower side members 6′ that are situated between the successive crossmembers 6″ of the first wedging elements 6 engage, if appropriate via ribbed edges, with the upper end 2′ and lower end 2″ of the cylindrical battery elements 2, if appropriate under pressure and/or with elastic deformation, said battery elements 2 forming, with the two first wedging elements 6 that confine them between one another, a battery sub-module 10 in the form of a block.

These blocks 10 form modular assemblies that are preassembled before they are fitted as a group in a housing 5 of the support body 4.

In these blocks 2″, which comprise for example 4 or 8 battery elements 2 each, the elements 2 can be oriented in an identical or non-identical manner (for example each half of the elements 2 may have its own orientation, which is the reverse of that of the other half).

Thus, each battery element 2 is held in two opposite frames that are each closed by two lateral crossmembers 6″ and two, upper and lower, side member portions 6′ of two first, opposite wedging elements 6 (FIG. 6).

Each pair of mutually opposite first wedging components 6 thus forms a cage confining at least a part of the battery elements 2 of the row Ri received in the profiled housing 5 in question. The alignment of elements 2 in the row is thus segmented or subdivided by these pairs of opposite components 6 into modular structural and functional units, each enclosing several elements (4, 8 or 12 for example).

As is shown in FIGS. 1, 2, 4, 5, 9, 14 and 15 in particular, the projections 7′ of the or each second wedging element 7 extend in rows above the lateral walls 5″ of the elongate housings 5, have chamfered or beveled surfaces 7″ and each come into engagement with the upper side members 6′ of the two first wedging elements 6 situated on either side of the lateral wall 5″ in question.

A pressure exerted on the second wedging element 7, of which there is preferably one for a given module 1, thus moves the two first wedging elements in question apart from one another and from the wall 5″ that separates them.

The side members 6′ advantageously have complementary sites 11 that cooperate with said projections 7′ so as likewise to effect fixing in the longitudinal direction DL of the elongate housings 5 between said first wedging elements 6 and second wedging element(s) 7 (and therefore likewise locking the battery elements 2 in position in said direction DL).

Advantageously, the or each second wedging element 7 consists of a meshwork plate having projections 7′ at the intersections of the mesh, these projections 7′ advantageously having a conical or frustoconical shape and the complementary sites 11 of the side members 6′ of the first wedging members 6 then consisting of partially circular cutouts that are preferably each situated facing a crossmember 6″ (FIGS. 1, 5, 6, 11 and 12).

The perforated plate(s) forming the second wedging elements 7 may, furthermore, have second formations 7′″ in the form of pegs or spikes, which can serve as insertion stops for the first projections 7′ and/or as securing means involving interlocking in complementary sites and/or as positioning stops for the plates, strips or terminals forming the upper connection means 14′, which are complementary to the lower conductive strips 14.

In accordance with a design feature that is beneficial to the invention, reinforcing and stiffening the support body 4 and contributing to the wedging of the battery elements 2 in the housings 5, provision may be made for the bases of the lateral walls 5″ of the elongate housings 5, said bases being connected to the bottom wall 8 of the support body 4, to have, in cross section, a shape that flares in the direction of the common bottom wall 8, thereby forming a junction zone 12 with beveled surfaces 12′, i.e. surfaces that are inclined with respect to the bottoms 5′ of the housings 5, and for the lower side members 6′ of the first wedging elements 6 to come to bear, under the pressure of the projections 7′ of the second wedging element(s) 7, and if appropriate under the weight of the battery elements 2 that they confine or frame, against the beveled surfaces 12′, and thus to be urged toward said battery elements 2 (FIGS. 5, 7, 10, 11 and 13).

The lower side members 6′ advantageously have an opposite bevel to that 12′ of the bottoms 5′ of the housings 5 (FIGS. 11A and 11B), in order to cooperate optimally with the junction zones 12.

Moreover, in order to simultaneously ensure secure locking in position, in spite of manufacturing tolerances, in particular in the direction of the longitudinal axes AL of the battery elements 2, in an isolated manner or in blocks 10, and at the same time to ensure the necessary electrical connection between these elements 2, the invention advantageously provides for the battery elements 2 to come to bear against the bottoms 5′ of the housings 5 that receive them via flexible strips 13 of elastically compressible material, which is a good heat conductor and preferably an electrical insulator, each flexible strip 13 extending over at least a part of the housing 5 in question. Moreover, electrically conductive lines or strips 14 that form part of the means 14′ for electrically connecting the battery elements 2 together are disposed between said battery elements 2 and said flexible strips 13, in a manner integrated or not integrated therewith (FIGS. 4, 5, 11, 13 and 15).

The elastic compressibility of the material forming the flexible strips 13 makes it possible to ensure that all the battery elements 2 of a module 1 are immobilized in spite of any manufacturing and/or assembly discrepancies and to avoid hard impacts and the generation of noise in the event of vibrations.

According to another aspect of the invention, relating to the problem of temperature control, at least the common bottom wall 8 defining the bottoms 5′, of the different elongate housings 5 of the support body 4 and preferably also their lateral walls 5″, is (are) made of a material that is a good heat conductor, each elongate housing 5 having, at its bottom 5′, a formation 15 that defines a profiled protruding surface that serves as a support base for the battery elements 2 received in the housing 5 in question, advantageously via compressible strips 13, 14 that are electrically insulating or conductive, respectively, and thermally conductive.

Preferably, the profiled support body 4 is made entirely and in one piece from a material that is a good heat conductor, advantageously a metal material, preferably aluminum or an alloy thereof, for example in the form of an extruded component. Advantageously, the first wedging elements 6 and second wedging element(s) 7 consist of components injection molded from plastics material.

The temperature control of the support body 4 and of the battery elements 2 by a suitable means can be realized in different ways, for example by the Peltier effect, by exposure of a temperature-controlled forced air flow or the like.

However, according to one embodiment which is effective, economical and easily structurally integrable, provision is advantageously made for the bottoms 5′ of the different elongate housings 5 of the support body 4, which, where appropriate, form a common bottom wall 15, to be subjected to the action of a thermal control means 16, for example of the type involving the circulation of a heat-transfer fluid 16′, this thermal control means 16 either being attached to the support body 4 of the module 1, in that it belongs to one module 1 or is shared between two modules 1, or being associated with said module 1 by being in contact therewith, being secured thereto or cooperating therewith, in that it belongs to a set of thermal control means common to several modules 1.

Such a thermal control means 16 may also be easily connected to the fluid circulation circuits of a vehicle, in the case of an onboard battery.

In order to promote and optimize the transmission of the effects of the thermal control between the walls 5″ and the air circulating by natural (or forced) convection, provision may also be made for the lateral walls 5″ of the elongate housings 5 to have, on their two opposite faces, a non-flat surface structure 17, for example a pattern of ribs/grooves or profiled undulations.

The different technical provisions mentioned above make it possible to arrive at optimized thermal control in the case of battery elements 2 that exhibit much higher thermal conduction (by a factor of at least 5, or preferably at least by a factor of 10) along their longitudinal axis AL than in their radial direction, this being associated with a circular cylindrical or at least elliptical shape.

Specifically, the bearing of the battery elements 2 on the strips 13, 14 (the strips 13 being made for example of filled silicone and the strips or lines 14 being metallic) and on the bottom wall 8, these all being thermally conductive, allows good heat transfer by conduction at the bottoms 5′ of the housings 5.

In addition, on account of their cylindrical outer shape, the battery elements 2 have an outer lateral surface that is entirely exposed to the circulation of natural air internal to the module 1, even when the adjacent elements 2 of a block 10 or of a row Ri are in contact (maximum occupation density). However, the fixing of a free interval, even a narrow slot (for example at most equal to 1 mm in width), between two adjacent elements 2 can contribute favorably to a circulation of air around said elements 2 and therefore to the thermal control thereof by natural volumetric air circulation, without compromising the energy storage density of the module 1.

Furthermore, a perforated structure, for the one part, of the crossmembers 6″ of the first wedging elements 6 in the form of ladders or of frames with cross pieces and, for the other part, of the plate forming the second wedging element 7, and also a height of the compartmentalizing walls 5″ less than that of the blocks 10 also promotes the circulation of air by natural convection in a battery 22 containing one or more battery modules 1.

In addition, through the subdivision into several levels of the group of battery elements 2 forming the module 1, the effects of temperature control are felt at the very heart of the collection of battery elements 2, by exposing them individually to the temperature control action of the conductive lateral and bottom walls 5″ and 8—control transposed directly to the interior of the group of battery elements 2 forming the module 1.

Said strips or lines 14 are advantageously part of a device for electrically interconnecting the different elements 2 in the form of a set of lower 14 and upper 14′ bars that connect together adjacent elements 2 in order to connect them in parallel, these groups of elements 2 in parallel of one and the same row Ri being themselves connected in series or in parallel/series (see arrangement and interconnection of the elements 2 in FIGS. 4, 6, 14B). This set of connection bars 14, 14′ is itself connected to the electrical connection means 1′ of the battery module 1 (see FIGS. 4 and 5).

More specifically, the electrical connection of the battery elements 2 of a module 1 may, for example, be organized advantageously on three different levels, depending in particular on the desired voltage/current ratio for a design of a given module 1 (total number of elements 2, length and number of housings 5 of the support body 4).

Thus, a first electrical connection level can be realized between the battery elements 2 of an alignment of elements 2 of a block 10: it can be of the parallel, parallel/series or series type depending on the desired characteristics.

A second electrical connection level can be realized between blocks 10, which are adjacent or non-adjacent, of a row Ri of elements 2 mounted in an aligned and wedged manner in an elongate housing 5 of the support body 4.

Lastly, the third electrical connection level can consist in linking the different rows Ri together and to a common connector 1′ for interfacing with and connecting to the outside that belongs to the module 1 in question.

These electrical connections between elements 2 of a block 10, between blocks 10 that make up a row Ri and between rows Ri of a module 1 are realized by combination of the lower conductive strips or lines 14 and the upper conductive strips 14′, together forming a structured electrical connection network linked to the lower and upper terminals of the elements 2, as can be seen in particular from the appended figures.

In accordance with a preferred design variant of the invention, which is both compact and effective and illustrated in particular in FIGS. 2 to 5 and 10, the thermal control means 16 that belongs to said module 1 comprises a wall 18, preferably made of a material that is an insulator or at least a slight heat conductor, that is attached to the external face of the common bottom wall 8 of the support body 4 and forms, by cooperation therewith, a sealed double bottom 19, means 20, 20′ for feeding heat-transfer liquid 16′ into the interior volume of the double bottom 19 and discharging it therefrom being integrated into said attached wall 18 or formed by being joined to the common bottom wall 8 of the support body 4.

Advantageously, the internal volume of the double bottom 19 comprises one or more path(s) for the heat transfer fluid 16′ to circulate between an inlet port 20 and an outlet port 20′, this/these path(s) being formed either only by formations 18′ integrated into the attached wall 18 of the double bottom 19 or by cooperation of mutually complementary formations present respectively on the common bottom wall 8 and on the attached wall 18.

The circulation paths may in particular comprise main circulation ducts 20″ formed laterally in the continuation of the ports 20 and 20′; and optionally transverse secondary circulation paths or routes (not shown specifically), fluid likewise being able to circulate through the entire volume of the double bottom 19, which may or may not be transversely compartmentalized.

In order to allow easy and strong assembly, provision may be made for the profiled support body 4 to have, along the lateral sides of the common bottom wall 8, outwardly protruding lips 21, and for the attached wall 18, which forms the double bottom 19 with the common bottom wall 8, to be secured to said support body 4 at said lips 21, for example by clip-fastening means 21′, by screw means or by similar mechanical assembly means.

The invention also relates, as shown in FIGS. 2 to 5 and 14 to 17, a battery 22 for a motorized vehicle, in particular for a hybrid or electric motor vehicle, characterized in that it comprises at least one battery module 1 as described above.

As can be seen from the abovementioned figures, the battery 22 may be adapted to a large number of formats (size, power) depending on the envisioned use (slave battery, main energy source, backup battery, etc.) and on the power and/or energy that is/are required.

According to a first embodiment of the invention, which can be seen in FIGS. 2 to 5, the battery 22 may comprise a single battery module 1, preferably provided with a thermal control means, and a cover 23, which is advantageously perforated and preferably made of an electrically insulating material, such as plastic or the like, the walls of which form a U shape and are configured to cover the open faces of the elongate housings 5 of the support body 4 of the module 1, so as to form, with the container 3, a continuous outer shell and a closed enclosure in which the battery elements 2 are held in a manner locked mechanically in position.

The cover 23 may in particular be fixed to reinforced lips or protruding end flanges 4′ of the outer lateral walls of the support body 4.

This cover 23 may be made in one piece or be formed of a plurality of constituent parts that are joined together.

This cover 23, which is fixed by being screwed or clip-fastened for example at lateral flanges or upper lips of the support body 4, may be involved in locking the second wedging element 7 in position on the blocks 10, for example by way of deformed or indented zones 23′ that engage by cooperating with projections 7′ at their recessed ends opposite to their conical ends that provide the beveled surfaces 7″.

According to a second embodiment of the invention, which can be seen in FIGS. 14 and 15, the battery 22 may also comprise two battery modules 1 that are joined together with their respective bottom walls 8 facing one another in a spaced-apart manner and a volume 19′ for heat-transfer fluid 16′ to circulate in being created in between, forming a common thermal control means 16 with inlet and outlet ports 20, 20′, and advantageously two covers 23, the walls of which each form a U shape and are configured to cover the open faces of the elongate housings 5 of one of the two support bodies 1, so as to form, with the two containers 3, two closed, side-by-side enclosures in which the battery elements 2 are held in a manner locked in position.

Lastly, according to a third embodiment of the invention, which is illustrated partially in FIGS. 16 and 17, the battery 22 may comprise at least two, preferably several, battery modules 1 disposed in a first casing part forming a tray 24 and having receiving locations 25 for said modules 1, each of said locations 25 having a thermal control means 16 either in the form of an indented wall portion that forms a double bottom with the bottom wall 8 of the support body 4 of a module 1, or in the form of a support surface for the bottom wall 8, which is temperature controlled, of the support body 4 of a battery module 1, a second casing part forming a cover 24′ being provided to create, by cooperation with the abovementioned first part 24, a closed casing.

The thermal control means integrated in the tray 24 and, if appropriate, in the cover 24′ of the casing may, for example, correspond to the control means described and shown in more detail in the French patent applications 1853129, 1853131 et 1856167 in the name of the applicant.

The invention also relates to a method for producing a battery module 1 as described above, characterized in that it consists essentially in forming battery sub-modules 10 by confining a plurality of battery elements 2 between two first wedging elements 6 in the form of frames provided with transverse crossmembers 6″, in fitting these sub-modules 10 in the different elongate housings 5 of a profiled support body 4 having a comb-shaped section, advantageously with elastically compressible and conductive strips 13, 14 being interposed at the bottoms 5′ of the housings 5, in fitting complementary means for electrically connecting the different battery elements 2, in attaching at least one second wedging element 7 above the elongate housings 5, this engaging with the first wedging elements 6 and locking the sub-modules 10 in position in the housings 5, preferably with pressurization, on account of said second wedging element 7 being fixed to the support body 4 and/or of the bearing of a cover 23 at least partially covering said support body 4.

Lastly, the invention also relates to a method for manufacturing a battery 22 as described above.

This method is characterized in that it consists in producing one or more battery module(s) (1), advantageously by implementing the method for producing a battery module, and then, depending on the desired type of resultant battery 22, in carrying out one of the three following sets of consecutive operations a), b) or c):
a) attaching a thermal control means 16 to the bottom wall 8 of the support body 4 of a module 1 and closing the container 3 of this module 1 with a cover 23 of which the walls form a U shape and are configured to cover the open faces of the housings 5 of said container 3;
b) joining together two modules 1 by way of the bottom walls 8 of their respective support bodies 4, with the production of a common thermal control means 16, and closing each of the two containers 3 with a cover 23 of which the walls form a U shape and are configured to cover the open faces of the housings 5 of the container 3 of the module 1 in question in each case;
c) disposing a plurality of modules 1 in a first casing part 24 forming a tray, each in a dedicated receiving location 25 which either has a thermal control means 16 in the form of a support surface for the bottom wall 8, which is temperature controlled, of the support body 4 of the module 1 in question, or has an indented wall portion forming a double bottom by cooperation with the bottom wall 8 of the support body 4 of the module 1 in question, said double bottom being connected to means for heat-transfer fluid 16′ to circulate in which are integrated in the tray 24, in optionally installing the electrical connections of the various modules to one another and to the connecting means of the battery 22, and, finally, in fitting and joining to the tray 24 a second casing part 24′ forming a cover, the two parts 24, 24′ forming a closed casing by cooperation.

Of course, the invention is not limited to the embodiments described and shown in the appended drawings. Modifications remain possible, in particular as regards the makeup of various elements or by substitution of equivalent techniques, without otherwise departing from the scope of protection of the invention.

1. An electric battery module having a plurality of individual accumulators in the form of battery elements or cells, of elongate, advantageously cylindrical, shape, these battery elements being connected electrically together and to the connection terminals of the module and mounted in a container forming part of said module,
wherein said container of said battery module comprises:
at least one support body which defines a plurality of mutually parallel elongate housings that are configured in the form of grooves or channels each for receiving a row of battery elements with their longitudinal axes perpendicular to the bottom of the housing in question,
first wedging elements in the form of ladder- or frame-like perforated components which comprise side members and crossmembers, disposed against and between the battery elements of a row and each of the two lateral walls of the elongate housing receiving them, wherein each crossmember is situated between two adjacent battery elements with which it is in contact, such that each battery element is fixed in position at least in the longitudinal direction of its elongate housing with respect to said first wedging elements,
at least one second wedging element which is mounted above the elongate housings and has projections that engage under pressure with the first wedging elements so as to urge the latter toward the bottoms of said elongate housings and against the battery elements that they frame in pairs.

2. The battery module as claimed in claim 1, wherein the support body is a profiled component of comb-shaped cross section, comprising a plurality of parallel compartmentalizing walls that are regularly spaced apart from one another and form, with a common bottom wall, the elongate housings.

3. The battery module as claimed in claim 1, wherein each battery element is, in a plane perpendicular to its longitudinal axis, kept in position between two first wedging elements by at least linear, contact with two pairs of crossmembers, each pair belonging to one of said abovementioned first wedging elements, said crossmembers being advantageously configured and arranged such that each battery element is positioned fixedly at a distance, for the one part, from two opposite lateral walls of the housing that receives it and, for the other part, from the adjacent battery elements, with respective determined spacings.

4. The battery module as claimed in claim 3, wherein each crossmember has, along at least a part of its length, continuously or discontinuously, at least one pair of beveled, flat or curved, contact surfaces that are intended to come into contact with two adjacent battery elements of a row.

5. The battery module as claimed in of claim 1, wherein those portions of upper and lower side members that are situated between the successive crossmembers of the first wedging elements engage, if appropriate via ribbed edges, with the upper end and lower end of the cylindrical battery elements, if appropriate under pressure and/or with elastic deformation, said battery elements forming, with the two first wedging elements that confine them between one another, a battery sub-module in the form of a block.

6. The battery module as claimed in claim 1, wherein the projections of the or of every second wedging element extend in rows above the lateral walls of the elongate housings, have chamfered or beveled surfaces and each come into engagement with the upper side members of the two first wedging elements situated on either side of the lateral wall in question, these side members advantageously having complementary sites that cooperate with said projections so as to likewise effect fixing in the longitudinal direction of the elongate housings between said first wedging elements and second wedging element(s).

7. The battery module as claimed in claim 6, wherein the or each second wedging element is a meshwork plate having projections at the intersections of the mesh, these projections advantageously having a conical or frustoconical shape and the complementary sites of the side members of the first wedging members then being partially circular cutouts that are each situated facing a crossmember.

8. The battery module as claimed in claim 1, wherein the bases of the lateral walls of the elongate housings, said bases being connected to the bottom wall of the support body, have, in cross section, a shape that flares in the direction of the common bottom wall, thereby forming a junction zone with beveled surfaces, i.e. surfaces that are inclined with respect to the bottoms of the housings, and in that the lower side members of the first wedging elements come to bear, under the pressure of the projections of the second wedging element(s), and if appropriate under the weight of the battery elements that they confine or frame, against the beveled surfaces, and are thus urged toward said battery elements.

9. The battery module as claimed in of claim 1, wherein the battery elements come to bear against the bottoms of the housings that receive them via flexible strips of elastically compressible material, which is a good heat conductor, each flexible strip extending over at least a part of the housing in question, electrically conductive lines or strips that form part of the means for electrically connecting the battery elements together being disposed between said battery elements and said flexible strips, in a manner integrated or not integrated therewith.

10. The battery module as claimed in claim 1, wherein at least the common bottom wall defining the bottoms, of the different elongate housings of the support body, is made of a material that is a good heat conductor, each elongate housing having, at its bottom, a formation that defines a profiled protruding surface that serves as a support base for the battery elements received in the housing in question, advantageously via compressible strips that are electrically insulating or conductive, respectively, and thermally conductive.

11. The battery module as claimed in claim 1, wherein the profiled support body is made entirely and in one piece from a material that is a good heat conductor, advantageously a metal material, and in that the first wedging elements and second wedging element(s) are components injection molded from plastics material.

12. The battery module as claimed in any one of claim 1, wherein the bottoms of the different elongate housings of the support body, which, where appropriate, form a common bottom wall, are subjected to the action of a thermal control means, for example of the type involving the circulation of a heat-transfer fluid, this thermal control means either being attached to the support body of the module, in that it belongs to one module or is shared between two modules, or being associated with said module by being in contact therewith, being secured thereto or cooperating therewith, in that it belongs to a set of thermal control means common to several modules.

13. The battery module as claimed in any one of claim 1, wherein the lateral walls of the elongate housings have, on their two opposite faces, a non-flat surface structure, for example a pattern of ribs/grooves or profiled undulations.

14. The battery module as claimed in claim 12, wherein the thermal control means that belongs to said module comprises a wall, that is attached to the external face of the common bottom wall of the support body and forms, by cooperation therewith, a sealed double bottom, means for feeding heat-transfer liquid into the interior volume of the double bottom and discharging it therefrom being integrated into said attached wall or formed by being joined to the common bottom wall of the support body.

15. The battery module as claimed in claim 14, charactcrizcd in that wherein the internal volume of the double bottom comprises one or more path(s) for the heat transfer fluid to circulate between an inlet port and an outlet port, this/these path(s) being formed either only by formations integrated into the attached wall of the double bottom or by cooperation of mutually complementary formations present respectively on the common bottom wall and on the attached wall.

16. The battery module as claimed in claim 14, wherein the profiled support body has, along the lateral sides of the common bottom wall, outwardly protruding lips, and in that the attached wall, which forms the double bottom with the common bottom wall, is secured to said support body at said lips, for example by clip-fastening means, by screw means or by similar mechanical assembly means.

17. A battery for a motorized vehicle, comprising: at least one battery module as claimed in claim 1.

18. The battery as claimed in claim 17, wherein said battery comprises a single battery module and a cover, which is perforated, the walls of which form a U shape and are configured to cover the open faces of the elongate housings of the support body of the module, so as to form, with the container, a continuous outer shell and a closed enclosure in which the battery elements are held in a manner locked mechanically in position.

19. The battery as claimed in claim 17, wherein said battery comprises two battery modules that are joined together with their respective bottom walls facing one another in a spaced-apart manner and a volume for heat-transfer fluid to circulate in being created in between, forming a common thermal control means with inlet and outlet ports, and advantageously two covers, the walls of which each form a U shape and are configured to cover the open faces of the elongate housings of one of the two support bodies, so as to form, with the two containers, two closed, side-by-side enclosures in which the battery elements are held in a manner locked in position.

20. The battery as claimed in claim 17, wherein said battery comprises at least two battery modules disposed in a first casing part forming a tray and having receiving locations for said modules (1), each of said locations (25) having a thermal control means either in the form of an indented wall portion that forms a double bottom with the bottom wall of the support body of a module, or in the form of a support surface for the bottom wall, which is temperature controlled, of the support body of a battery module, a second casing part forming a cover being provided to create, by cooperation with the abovementioned first part, a closed casing.

21. A method for producing a battery module as claimed in claim 1, said method comprising: forming battery sub-modules by confining a plurality of battery elements between two first wedging elements in the form of frames provided with transverse crossmembers, in fitting these sub-modules in the different elongate housings of a profiled support body having a comb-shaped section, advantageously with elastically compressible and conductive strips being interposed at the bottoms of the housings, in fitting complementary means for electrically connecting the different battery elements, in attaching at least one second wedging element above the elongate housings, this engaging with the first wedging elements and locking the sub-modules in position in the housings, on account of said second wedging element being fixed to the support body and/or of the bearing of a cover at least partially covering said support body.

22. A method for manufacturing a battery as claimed in claim 17, said method comprising producing one or more of said battery module(s), and then, depending on the desired type of resultant battery, in carrying out one of the three following sets of consecutive operations a), b) or c):
a) attaching a thermal control means to the bottom wall of the support body of a module and closing the container of this module with a cover of which the walls form a U shape and are configured to cover the open faces of the housings of said container;
b) joining together two modules by way of the bottom walls of their respective support bodies , with the production of a common thermal control means, and closing each of the two containers with a cover of which the walls form a U shape and are configured to cover the open faces of the housings of the container of the module in question in each case;
c) disposing a plurality of modules in a first casing part forming a tray, each in a dedicated receiving location which either has a thermal control means in the form of a support surface for the bottom wall, which is temperature controlled, of the support body of the module in question, or has an indented wall portion forming a double bottom by cooperation with the bottom wall of the support body of the module in question, said double bottom being connected to means for heat-transfer fluid to circulate in which are integrated in the tray, in optionally installing the electrical connections of the various modules to one another and to the connecting means of the battery, and, finally, in fitting and joining to the tray a second casing part forming a cover, the two parts forming a closed casing by cooperation.
